(19) United States
(12) Patent Application Publication
(10) Pub. No.: US 2026/0169519 A1
(43) Pub. Date: Jun. 18, 2026

(54) PMD AND CROSSBAR SYNCHRONIZATION TECHNIQUES FOR FAST RECONFIGURATION AND DATA INTEGRITY

(71) Applicant: MaxLinear, Inc., Carlsbad, CA (US)

(72) Inventors: Curtis Ling, Carlsbad, CA (US); Masoud Koochakzadeh, Carlsbad, CA (US); Sheng Ye, Carlsbad, CA (US); John Andrew Guckenberger, Carlsbad, CA (US); Sridhar Ramesh, Carlsbad, CA (US)

(73) Assignee: MaxLinear, Inc., Carlsbad, CA (US)

(21) Appl. No.: 19/418,792

(22) Filed: Dec. 12, 2025

Related U.S. Application Data
(60) Provisional application No. 63/733,365, filed on Dec. 12, 2024.

(51) Int. Cl. G06F 1/14

(52) U.S. Cl. CPC G06F 1/14

(57) ABSTRACT

Technology for a device may include a plurality of digital signal processors (DSPs); and a plurality of analog crossbars operable to be connected to the plurality of DSPs. The timing between the plurality of DSPs may be synchronized.

### RELATED APPLICATION

This application claims the benefit of U.S. Provisional Application No. 63/733,365, filed Dec. 12, 2024, the disclosure of which is incorporated herein by reference in its entirety.

The examples discussed in the present disclosure are related to PMD and crossbar synchronization techniques for fast reconfiguration and data integrity.

### BACKGROUND

Unless otherwise indicated herein, the materials described herein are not prior art to the claims in the present application and are not admitted to be prior art by inclusion in this section.

Datacenters and artificial intelligence (AI) clusters may use Ethernet switches that are packet switched. Using a packet switched Ethernet switch results in delivery that is not reliable, is variable, and has high latency. Fabric switches provide another possibility in datacenters and AI clusters. Fabric switches, unlike Ethernet switches, are equivalent to circuit-switched networks, rather than packet-switched networks.

The subject matter claimed in the present disclosure is not limited to examples that solve any disadvantages or that operate only in environments such as those described above. Rather, this background is only provided to illustrate one example technology area where some examples described in the present disclosure may be practiced.

### SUMMARY

A device may include digital signal processors (DSPs) and analog crossbars connected to the DSPs. The timing between DSPs may be synchronized. A method may include connecting DSPs to analog crossbars and synchronizing DSPs to a shared clock signal across DSPs. A method may include connecting DSPs to analog crossbars; and maintaining an independent data rate at DSPs.

The objects and advantages of the examples will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Examples will be described and explained with additional specificity and detail through the use of the accompanying drawings in which:

FIG. 1A illustrates an example device including digital signal processors (DSPs) and analog crossbars.

FIG. 1B illustrates an example device including processing units (XPUs) and analog crossbars.

FIG. 2 illustrates an example device including digital signal processors (DSPs) and analog crossbars.

FIG. 3 illustrates an example timing diagram used for synchronization.

FIG. 4 illustrates an example process flow of a device for synchronization.

FIG. 5 illustrates an example process flow of a device for synchronization.

FIG. 6 illustrates an example communication system operable for synchronization.

FIG. 7 illustrates a diagrammatic representation of a machine in the example form of a computing device within which a set of instructions, for causing the machine to perform any one or more of the methods discussed herein, may be executed.

FIG. 8A illustrates an example block diagram of a data center.

FIG. 8B illustrates an example switch device.

FIG. 8C illustrates an example switch device.

FIG. 8D illustrates an example switch device.

### DESCRIPTION

The systems and methods described herein provide synchronization techniques between Physical Media Dependent (PMD) devices and crossbars to enable fast and efficient reconfiguration of switches, ensuring data integrity and reduced latency during traffic transitions. By leveraging a common time base, synchronized reconfiguration processes, and advanced flow control mechanisms, the system enhances the reliability and performance of switching operations in high-speed communication networks.

Some examples herein include use of a common time base to synchronize PMDs and crossbars. This synchronization minimizes jitter and symbol drift, enabling seamless transitions during reconfiguration events. By aligning the clock signals of multiple PMDs and crossbars, the system ensures accurate data flow and improves the overall stability of the network.

In some examples, to further enhance efficiency, the system employs synchronized reconfiguration techniques. Crossbars and PMDs work in tandem to ensure traffic transitions occur with reduced latency, preserving the continuity of data streams during switching operations. This coordination between components reduces the disruption typically associated with reconfiguration events.

Additionally, the system incorporates fast reacquisition mechanisms, including the use of look-up tables (LUTs) to store prior configuration states and equalization settings. These pre-stored parameters significantly reduce the time required for reacquisition after reconfiguration, enabling rapid recovery of normal operation without compromising data integrity.

To prevent traffic bottlenecks and data loss during reconfiguration, the system uses backpressure and flow control mechanisms. These mechanisms dynamically regulate traffic flow, ensuring that no data is dropped or delayed unnecessarily, even under heavy load conditions. By managing traffic across the system efficiently, the system maintains high levels of reliability and throughput.

The examples herein include an approach to PMD and crossbar synchronization that be applied in various environments, including data centers, telecommunications networks, and Internet of Things (IoT) applications. By addressing the challenges of reconfiguration latency, traffic management, and data integrity, the system provides a robust solution for high-performance communication systems.

Examples of the described herein will be explained with reference to the accompanying drawings.

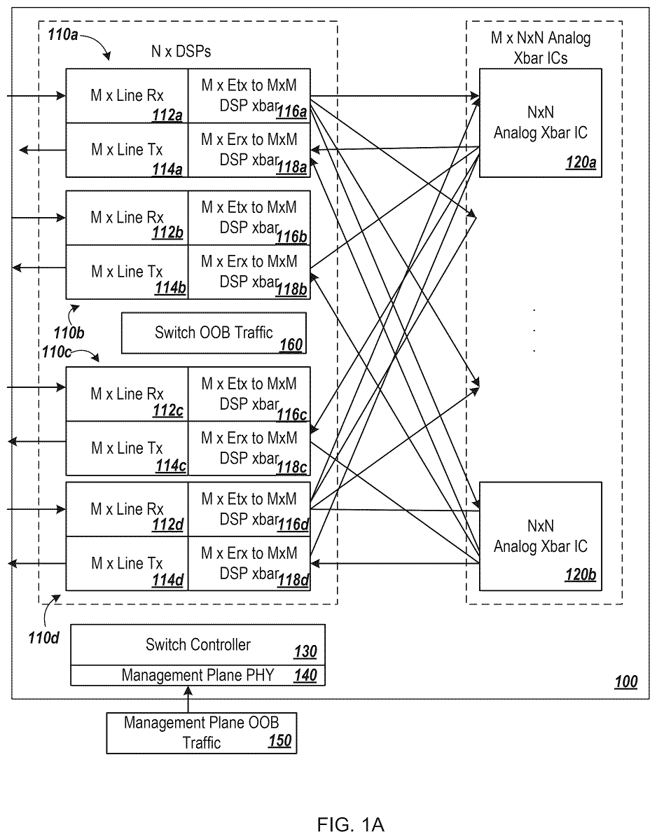

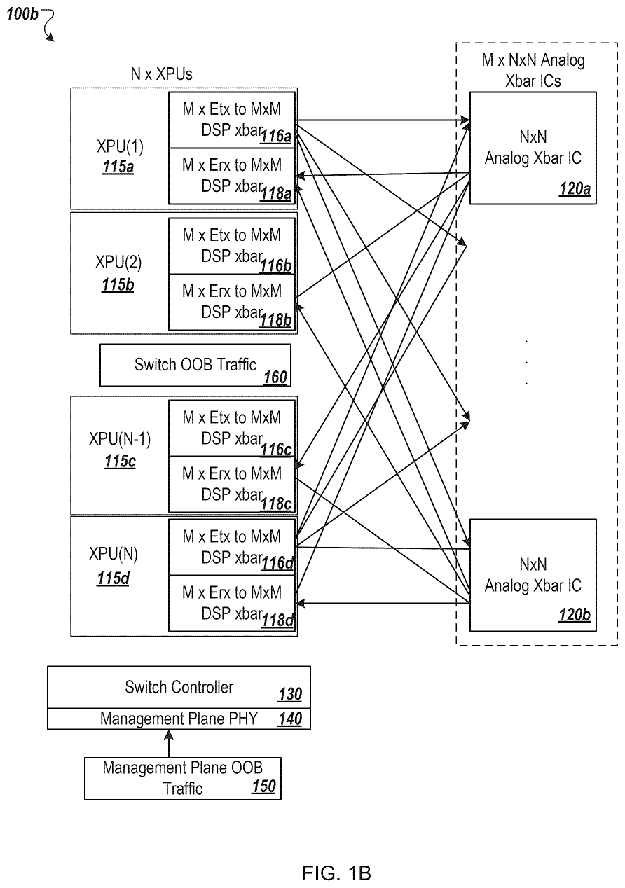

As illustrated in FIG. 1A, analog electrical circuit switch (AECS) 100 may include one or more digital signal processors 110a, 110b, 110c, 110d. The AECS may include a switch controller 130. The AECS may include one or more analog crossbars (“xbar”) integrated circuits (IC) (e.g., analog crossbars 120a, 120b).

The DSPs 110a, 110b, 110c, 110d may be devices integrating layer 1 (L1) for line and switch side inputs and outputs. A DSP 110a may include an M×Line Rx 112a, an M×Line Tx 114a, an M×ETx to M×M DSP xbar 116a, and an M×ERx to M×M DSP xbar 118a. A DSP 110b may include an M×Line Rx 112b, an M×Line Tx 114b, an M×ETx to M×M DSP xbar 116b, and an M×ERx to M×M DSP xbar 118b. A DSP 110c may include an M×Line Rx 112c, an M×Line Tx 114c, an M×ETx to M×M DSP xbar 116c, and an M×ERx to M×M DSP xbar 118c. A DSP 110d may include an M×Line Rx 112d, an M×Line Tx 114d, an M×ETx to M×M DSP xbar 116d, and an M×ERx to M×M DSP xbar 118d. A DSP xbar may be a digital crossbar integrated in the DSP.

A physical media-dependent (PMD) device may include a DSP 110a, 110b, 110c, 110d. The PMD may be an electrical-optical module or an electrical-electrical module. A client may be a system communicating line-side in-band traffic to the AECS 100. For example, a server may be a system communicating line-side in-band traffic to the AECS 100. Line-side in-band (IB) bandwidth may be line traffic communicated to or from a client. IB switch traffic may be IB traffic directed into or out of or within the AECS 100.

In some examples, the switch controller (SC) 130 may manage and control AECS 100 devices. In one example, the switch controller 130 may be a microcontroller unit (MCU). Alternatively or in addition, the switch controller 130 may be a DSP. Switch out-of-band (OOB) traffic may be traffic among the SC 130, DSP 110a, 110b, 110c, 110d, analog crossbars 120a, 120b carried on a different network and physical layer than IB; may be carried on analog crossbars 120a, 120b with redundancy. An “Xbar IC” may be an analog Xbar IC which may be a chip implementing an analog crossbar with input and output lanes.

Management plane OOB traffic may be traffic from outside the AECS via management plane PHY to configure and manage the AECS.

In one example, a device may include DSPs 110a, 110b, 110c, 110d and analog crossbars 120a, 120b connected to the DSPs 110a, 110b, 110c, 110d. The timing between the DSPs 110a, 110b, 110c, 110d may be synchronized. The timing between the DSPs 110a, 110b, 110c, 110d may be synchronized using DSP 110a, 110b, 110c, 110d, or the timing between the DSPs 110a, 110b, 110c, 110d may be synchronized using a switch controller 130.

The DSPs 110a, 110b, 110c, 110d, the switch controller 130, and/or the analog crossbars 120a, 120b may be interconnected in various ways. For example, OOB signaling with the AECS may include a separate physical layer and/or connectivity among the DSPs 110a, 110b, 110c, 110d, the switch controller 130, and/or the analog crossbars 120a, 120b. For example, serial peripheral interface, (SPI), inter-integrated circuit (I2C), other out-of-band input/output modes, or the like may be used for communication among the DSPs 110a, 110b, 110c, 110d, the switch controller 130, and/or the analog crossbars 120a, 120b. Communication between the DSPs 110a, 110b, 110c, 110d, the switch controller 130, and/or the analog crossbars 120a, 120b may be used for control, management, synchronization, or the like.

The DSPs 110a, 110b, 110c, 110d, the switch controller 130, and/or the analog crossbars 120a, 120b may use separate wiring. For example, star wiring, daisy chain wiring, mesh wiring, or the shared use of redundant capacity for the analog crossbars may be used.

The interconnections between the DSPs 110a, 110b, 110c, 110d, the switch controller 130, and/or the analog crossbars 120a, 120b may be used to: (i) maintain medium access protocol (MAP) cycles, (ii) synchronize the DSPs, the analog crossbars, the switch controller, or the like, (iii) to update the AECS state, or (iv) to update tables.

The analog crossbars may be synchronized to the DSPs and/or the switch controller. This synchronization may occur using e.g., Institute of Electrical and Electronics Engineering (IEEE) 1588 and/or a shared clock signal and/or shared reference signal. The analog crossbars may use on-chip or off-chip controllers or logic, e.g., for configuring, synchronizing, managing, or the like. The analog crossbars may have heartbeat functionality to confirm operational status. The analog crossbars may maintain a time base which may be synchronous with a reference. The analog crossbars may switch among a set of states in a programmable pattern. The switching may be synchronous with some reference, e.g., a network controller, a DSP time base, or the like.

As illustrated in the system 100b in FIG. 1B, one or more XPUs 115a, 115b, 115c, 115d (e.g., N XPUs) may be connected to one or more analog crossbars 120a, 120b (e.g., M N×N analog xbar ICs) in an any-to-any configuration.

For example, XPU 115a may include M×Etx to M×M DSP xbar 116a and M×Erx to M×M DSP xbar 118a. M×Etx to M×M DSP xbar 116a may be coupled to the one or more analog crossbars 120a, 120b and M×Erx to M×M DSP xbar 118a may be coupled to the one or more analog crossbars 120a, 120b.

In addition or alternatively, XPU 115b may include M×Etx to M×M DSP xbar 116b and M×Erx to M×M DSP xbar 118b. M×Etx to M×M DSP xbar 116b may be coupled to the one or more analog crossbars 120a, 120b and M×Erx to M×M DSP xbar 118b may be coupled to the one or more analog crossbars 120a, 120b.

In addition or alternatively, XPU 115c may include M×Etx to M×M DSP xbar 116c and M×Erx to M×M DSP xbar 118c. M×Etx to M×M DSP xbar 116c may be coupled to the one or more analog crossbars 120a, 120b and M×Erx to M×M DSP xbar 118c may be coupled to the one or more analog crossbars 120a, 120b.

In addition or alternatively, XPU 115d may include M×Etx to M×M DSP xbar 116d and M×Erx to M×M DSP xbar 118d. M×Etx to M×M DSP xbar 116d may be coupled to the one or more analog crossbars 120a, 120b and M×Erx to M×M DSP xbar 118d may be coupled to the one or more analog crossbars 120a, 120b.

In-band switch traffic may be directed to the input of the one or more analog crossbars 120a, 120b. In-band switch traffic may be directed from the output of the one or more analog crossbars 120a, 120b. Switch out-of-band traffic (which may be carried between the one or more XPUs 115a, 115b, 115c, 115d and the one or more analog crossbars 120a, 120b) may be carried on a management network or a sideband. The switch controller 130, the management plane PHY 140, the management plane OOB traffic 150, and the switch OOB traffic 160 may have similar functionality as provided in relation to FIG. 1A.

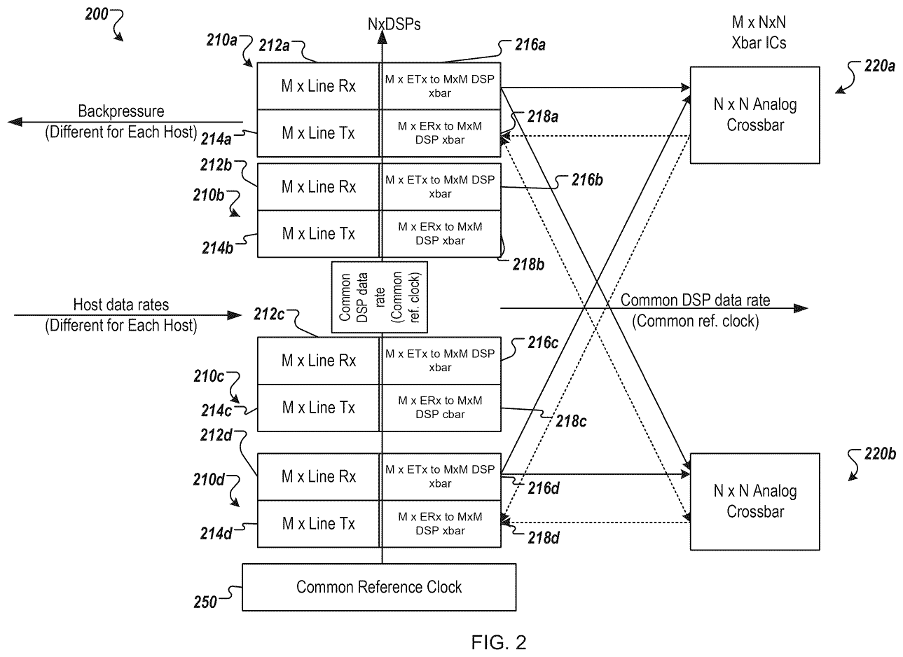

As illustrated in FIG. 2, a device 200 may include DSPs 210a, 210b, 210c, 210d that may include various functionality. For example, DSP 210a may include M×Line Rx 212a, M x Line Tx 214a, M×ETx to M×M DSP crossbar 216a, and M×ERx to M×M DSP crossbar 218a. For example, DSP 210b may include M×Line Rx 212b, M×Line Tx 214b, M×ETx to M×M DSP crossbar 216b, and M×ERx to M×M DSP crossbar 218b. For example, DSP 210c may include M x Line Rx 212c, M×Line Tx 214c, M×ETx to M×M DSP crossbar 216c, and M×ERx to M×M DSP crossbar 218c. For example, DSP 210d may include M×Line Rx 212d, M×Line Tx 214d, M x ETx to M×M DSP crossbar 216d, and M×ERx to M×M DSP crossbar 218d. Device 200 may also include analog crossbars 220a, 220b.

The timing between the DSPs 210a, 210b, 210c, 210d may be synchronized by DSPs 210a, 210b, 210c, 210d. The DSPs 210a, 210b, 210c, 210d may be synchronized to a common time base (e.g., a common reference clock 250). The common time base may be a common clock signal and/or a reference signal (e.g., which may be usable in a phase locked loop (PLL)). The common clock signal may be provided across the DSPs 210a, 210b, 210c, 210d, unlike a DSP 210a, 210b, 210c, 210d that uses its own local crystal. Synchronizing the DSPs 210a, 210b, 210c, 210d to a shared time base may facilitate precise timing used for data transfer and may reduce latency due to clock drift. Synchronizing the DSPs 210a, 210b, 210c, 210d may allow the DSPs to reconfigure without losing symbol timing. The DSPs may ignore the transients that may occur.

The DSPs 210a, 210b, 210c, 210d may be synchronized to a shared clock signal. The device 200 may use the shared clock signal. Alternatively or in addition, an independent clock may be used at DSP 210a, 210b, 210c, 210d. The shared clock signal may facilitate fast acquisition of timing (e.g., frequency, phase) after an AECS has been reconfigured. Another benefit of a shared clock signal may include reducing jitter, enhancing link performance, or the like. In addition or alternatively, synchronizing the DSPs and/or the analog crossbars 220a, 220b to a common clock signal may reduce symbol drift during traffic transitions. Referencing the DSPs to a shared clock signal may allow for fast reacquisition used for time multiplexing of output lanes because phase drift may be eliminated.

Alternatively or in addition, the DSPs 210a, 210b, 210c, 210d may synchronize the timing between the DSPs 210a, 210b, 210c, 210d using IEEE 1588. The common time base may be established and maintained through 1588 or similar protocol (“semi-synchronously”), which means DSPs may have slightly different baud using clock recovery unit (CRU) and longer reacquisition. A CRU may be used to recover symbol timing. In addition or alternatively, the device 200 may be operable with synchronous MAP cycles.

Alternatively or in addition, the DSPs 210a, 210b, 210c, 210d may maintain an independent data rate. A DSP may maintain an independent data rate on one or more of its input and/or output lanes. In some examples, DSPs 210a, 210b, 210c, 210d may share an independent data rate e.g., referencing a common clock signal distributed among the DSPs 210a, 210b, 210c, 210d.

Alternatively or in addition, the DSPs 210a, 210b, 210c, 210d may be syntonized. For example, a bittide mechanism may be used to achieve syntony. The mechanism that bittide may use for providing frequency-locking feedback to a given node's local clock may be the state (pointer location FIFO pointer (FP)) of the local node's FIFOs (“elastic buffers”, or “receive buffers”) that connect it to other nodes. The local node may compute the difference between the pointer FP and a desired FIFO set point (SP, e.g. mid-point of the FIFO) for each FIFO, average them, scale the average and feed this result to the frequency control of the local oscillator. A positive value signifies that on average the FIFOs are more full than desired, and therefore the local clock should increase its frequency to prevent overflow of the FIFOs. This mechanism is similar to a phase lock loop's phase detector.

### Synchronization Hierarchies

The implementation of synchronization hierarchies within the system provides a robust framework for ensuring tight coordination between PMDs and crossbars during high-speed switching operations. In one example, a master-slave clock architecture is employed, where a central clock source serves as the master, distributing a unified time base to all subordinate components, including DSPs and crossbars. This hierarchical approach minimizes timing discrepancies across the network, ensuring that all devices operate in harmony. Alternatively, distributed synchronization models may be utilized, where each component generates its own clock signal but synchronizes periodically with neighboring devices through mutual communication. This model is particularly advantageous in environments where a central clock is impractical, such as in distributed networks with multiple geographical nodes.

### Phase-Locked Loop (PLL) Implementation

To achieve precise synchronization, phase-locked loops (PLLs) are embedded within both DSPs and crossbars. These PLLs dynamically adjust the phase and frequency of local clocks to align with the system-wide time base. For example, each DSP integrates a high-resolution PLL that locks onto the master clock signal, ensuring minimal drift and precise timing for data transmission and reception. Similarly, the crossbars feature PLLs that continuously monitor and adjust to the clock signals from connected PMDs. These PLLs incorporate advanced filtering techniques to suppress noise and maintain stability even in environments with fluctuating clock frequencies. This tight synchronization enables seamless reconfiguration of switching paths without introducing latency or disrupting traffic flows.

### Jitter and Symbol Drift Measurement and Correction

The system includes real-time mechanisms for measuring and correcting jitter and symbol drift during operation. Jitter, which refers to short-term variations in signal timing, is continuously monitored using specialized circuitry within the DSPs and crossbars. These circuits measure deviations from expected timing intervals and relay this information to the synchronization controller. Similarly, symbol drift, which occurs over longer durations due to cumulative timing errors, is detected through periodic alignment checks between transmitted and received symbols. Once deviations are detected, the system dynamically adjusts clock frequencies or phases using the PLLs to bring the timing back into alignment. Additionally, error correction codes (ECCs) are employed at the data layer to ensure that any residual errors introduced by jitter or drift do not compromise data integrity.

### Synchronization in Varied Data Rates and Complex Topologies

The synchronization techniques described herein are designed to function effectively across diverse environments, including networks with varied data rates and complex topologies. For example, in optical networks with multiple wavelengths operating at different speeds, the system leverages wavelength-agnostic synchronization modules that maintain alignment across all channels. This ensures that data transmitted over high-speed optical links arrives in sync with data sent over lower-speed electrical connections. In topologies with multiple interconnected nodes, such as mesh networks or hybrid star-ring configurations, the system utilizes distributed synchronization models to propagate timing information across all nodes. Each node adjusts its local clock based on synchronization signals received from its nearest neighbors, maintaining global coherence even as data traverses multiple paths with varying latencies. The synchronization signals may be distributed by explicit wiring, through nearest neighbors, or by transferring timing through receiving serializer/deserializer (SERDES) stream recovered clock.

### Real-time Adaptation and Scalability

To address the challenges of scalability, the synchronization architecture is designed to adapt in real time as the network grows or changes. For example, as additional PMDs or crossbars are added to the system, the synchronization controller automatically incorporates these new elements into the timing hierarchy, ensuring seamless integration without requiring manual reconfiguration. Similarly, in environments with variable traffic patterns, such as data centers handling bursty workloads, the system dynamically reallocates synchronization resources to prioritize high-traffic paths. This adaptive approach enables the system to maintain high levels of performance and reliability in dynamic and complex network environments.

By combining hierarchical synchronization models, PLL-based timing control, real-time jitter correction, and adaptability to varied environments, the disclosed system delivers a comprehensive solution for achieving tight coordination between PMDs and crossbars. This ensures efficient reconfiguration, reduced latency, and robust data integrity across a wide range of applications.

In some examples, the DSPs 210a, 210b, 210c, 210d may have slightly different baud which may result in a clock recovery unit (CRU) being used. When DSPs 210a, 210b, 210c, 210d are temporarily disconnected, reacquisition may be used. Time may be saved because the channel may be static. That is, the feed forward equalization (FFE) and continuous-time linear equalization may be unchanged.

When the DSPs 210a, 210b, 210c, 210d maintain an independent data rate, backpressure may be used to adjust the flow of ingress data from client into the DSPs 210a, 210b, 210c, 210d. Within the device 200, the DSPs may use the same data rate which may be referenced to a shared clock signal.

Reconfiguration between the DSPs 210a, 210b, 210c, 210d and the analog crossbars may be synchronized to facilitate reduced or minimal latency between traffic flows. Seamless may also occur between traffic flows.

The reacquisition time after reconfiguration between the DSPs 210a, 210b, 210c, 210d and the analog crossbars 220a, 220b may be minimized by using one or more look up tables (LUTs) to store one or more of prior configuration states or equalization settings. LUTs may store DSP and/or crossbar configurations for different crossbar connection configurations. The DSPs 210a, 210b, 210c, 210d may have LUTs which store the equalization settings for connections (e.g. Xbar settings) in order to speed up acquisition and tracking when switching from one connection to another.

### Fast Reacquisition Using Look-Up Tables (LUTS)

In some examples, the use of Look-Up Tables (LUTs) provides a powerful mechanism for achieving rapid reacquisition of synchronization and connectivity after reconfiguration events in high-performance networks. LUTs are dynamically updated in real time to reflect changes in network topology, traffic patterns, and operational conditions, enabling the system to adapt seamlessly to varying scenarios. For instance, when a new connection is established or a redundant path is activated, the corresponding LUT entries are updated with the latest routing and configuration parameters. This ensures that subsequent reacquisition events can leverage pre-calculated settings, minimizing downtime and reducing the need for iterative recalibration.

At the DSP level, LUTs store advantageous equalization parameters, including pre-emphasis, de-emphasis, and gain settings for specific communication channels. These parameters are fine-tuned during initial configuration and updated periodically based on real-time feedback from error correction mechanisms and signal integrity monitors. For example, if a DSP detects increased noise or attenuation on a particular lane, the associated LUT entry is modified to include updated equalization settings that counteract these effects. This allows the DSP to rapidly reacquire and stabilize the connection without requiring a full recalibration cycle.

Similarly, at the crossbar level, LUTs store routing configurations and traffic flow priorities for different reconfiguration scenarios. Each entry in the crossbar's LUT corresponds to a unique combination of input and output lanes, specifying the optimal path for data transmission under current conditions. In cases where a primary path fails or becomes congested, the crossbar controller retrieves the corresponding LUT entry for a redundant path and immediately transitions traffic to the new route. This approach ensures that traffic flows remain uninterrupted and latency is kept to a minimum, even during dynamic network changes.

### Dynamic Updates and Scalability

One of the key features of the LUT-based approach is its ability to scale and adapt to dynamic network conditions. LUTs are continuously updated as part of the system's feedback loop, incorporating information from traffic monitors, synchronization controllers, and fault detection mechanisms. For instance, in a mesh network topology, changes in node connectivity or link bandwidth are immediately reflected in the LUTs at both the DSP and crossbar levels. This ensures that the system can handle complex reconfiguration scenarios, such as rerouting traffic around multiple failed nodes, without introducing significant delays.

Additionally, the LUTs are designed to support hierarchical updates, where changes at a higher level (e.g., network-wide topology adjustments) automatically propagate to lower levels (e.g., individual DSPs and crossbars). This hierarchical approach reduces the computational overhead of managing large-scale networks while maintaining precise control over individual components.

### Benchmarking and Optimizing Reacquisition Times

Reacquisition times are a advantageous performance metric for systems employing LUT-based synchronization and reconfiguration. To optimize these times, the system uses stored states and historical performance data to identify and implement the most efficient reacquisition strategies. For example, during a failover event, the system benchmarks the time taken to retrieve LUT entries, apply the stored configurations, and stabilize the connection. This data is then used to refine future LUT updates, ensuring that reacquisition processes become progressively faster over time.

Benchmarking is further enhanced by simulating a wide range of operational scenarios, including high-traffic conditions, multi-path routing, and simultaneous reconfiguration events across multiple components. The results of these simulations are used to pre-populate the LUTs with optimized settings for each scenario, reducing the need for real-time calculations during actual operation. In this way, the system achieves consistently low reacquisition times, even under challenging conditions.

### Use Cases for LUT-driven Reacquisition

The implementation of LUTs for fast reacquisition is particularly valuable in environments where low latency and high reliability are paramount. In data centers, for example, LUTs enable rapid recovery from switch failures or congestion, ensuring uninterrupted operation for mission-advantageous applications. In optical networks, where signal integrity is highly sensitive to timing and alignment, LUTs facilitate the rapid stabilization of optical links following reconfiguration. Similarly, in IoT networks, LUT-based reacquisition ensures seamless communication between sensors and controllers, even in dynamic and resource-constrained environments.

Traffic flow during reconfiguration between the DSPs 210a, 210b, 210c, 210d and the analog crossbars 220a, 220b may be managed using backpressure to prevent data loss. Over- or under-flow may avoided through, e.g., backpressure mechanisms. “Backpressure” may include ways of signaling (via protocol) to a sender that the rate is too high or low to allow sender to adjust DSPs that may manage independent data rates for input and output lanes, using backpressure techniques to avoid overflows or underflows. Bottlenecks may also be avoided.

The DSPs 210a, 210b, 210c, 210d may use synchronous MAP cycles. The DSPs 210a, 210b, 210c, 210d may establish a synchronous resource allocation cycle similar to MAP cycle between DSP and a Client, or across DSPs in a system. A switch controller may establish a timing base e.g., a MAP cycle across the DSPs 210a, 210b, 210c, 210d.

### Traffic Flow and Backpressure Mechanisms

For example, effective management of traffic flow is advantageous during reconfiguration events to prevent data loss, minimize bottlenecks, and ensure seamless transitions. One of the most effective techniques for managing traffic is the use of backpressure mechanisms, which regulate data flow in response to network congestion or reconfiguration bottlenecks. Backpressure enables the system to dynamically adjust traffic rates, ensuring that data packets are processed without overwhelming downstream components or communication channels.

### Signaling Protocols for Backpressure

Backpressure mechanisms are often implemented using well-established signaling protocols, such as Explicit Congestion Notification (ECN) or custom flow control protocols. ECN, for example, is a widely used protocol in IP-based networks that allows network devices to signal congestion to traffic sources without dropping packets. When congestion is detected, the ECN bit in the packet header is marked, signaling the sender to reduce its transmission rate. This proactive approach prevents congestion from escalating and helps maintain consistent traffic flow.

Custom flow control protocols can also be employed, particularly in specialized or proprietary network environments such as data centers or optical networks. For instance, a custom protocol might involve the use of control signals sent from crossbars to DSPs, instructing them to temporarily throttle their data transmission rates. These signals could be integrated into the out-of-band (OOB) communication channels, ensuring that the backpressure mechanism operates independently of the primary data flow and does not interfere with ongoing operations.

When underflow is present, then idle sequences may be inserted. When overflow is present, then backpressure may be used.

### Advantageous Scenarios for Backpressure

Backpressure becomes particularly advantageous during scenarios involving high traffic spikes or failover events. For example, during a traffic spike caused by sudden demand surges (e.g., a viral event in a content delivery network), the crossbars may experience temporary congestion. Backpressure mechanisms ensure that upstream devices, such as DSPs or PMDs, temporarily pause or slow their data transmission rates, allowing the congested crossbars to clear their buffers before resuming normal operation.

Similarly, during a failover event, where traffic must be rerouted to redundant lanes or components, backpressure mechanisms help manage the increased load on the backup paths. Without backpressure, the sudden influx of traffic on the redundant lanes could overwhelm the system, leading to packet loss or latency spikes. By signaling upstream devices to regulate their traffic rates, backpressure ensures a smooth transition to the backup paths, maintaining data integrity and minimizing latency.

### Mitigating Bottlenecks in High-latency Environments

In high-latency environments, such as satellite or wide-area networks (WANs), reconfiguration events can introduce significant bottlenecks due to the longer round-trip times required for control signals to propagate. To mitigate these bottlenecks, advanced backpressure mechanisms can be combined with predictive traffic management techniques. For instance, the system can analyze historical traffic patterns and anticipate periods of high congestion, preemptively signaling devices to adjust their transmission rates.

Another approach involves the use of buffered reconfiguration, where temporary buffers are deployed at key points in the network to store incoming traffic during reconfiguration. These buffers act as a safety net, preventing data loss while the system reconfigures its paths. Backpressure signals can then coordinate the release of buffered data, ensuring a controlled and orderly flow of traffic.

### Enhanced Backpressure With Multi-Level Flow Control

In some examples, to further enhance backpressure mechanisms, multi-level flow control can be implemented, where backpressure signals are propagated across multiple layers of the network hierarchy. For example, in a data center environment, backpressure at the crossbar level could trigger corresponding adjustments at the rack level and the network core level, creating a coordinated response to congestion. This hierarchical approach ensures that bottlenecks are addressed at all levels, preventing localized congestion from escalating into network-wide issues.

In some examples, credit-based flow control may be implemented as a backpressure mechanism. In some examples, syntonization may be used as a backpressure mechanism. In some examples, out-of-band signaling may be used to achieve a frequency lock e.g., by averaging.

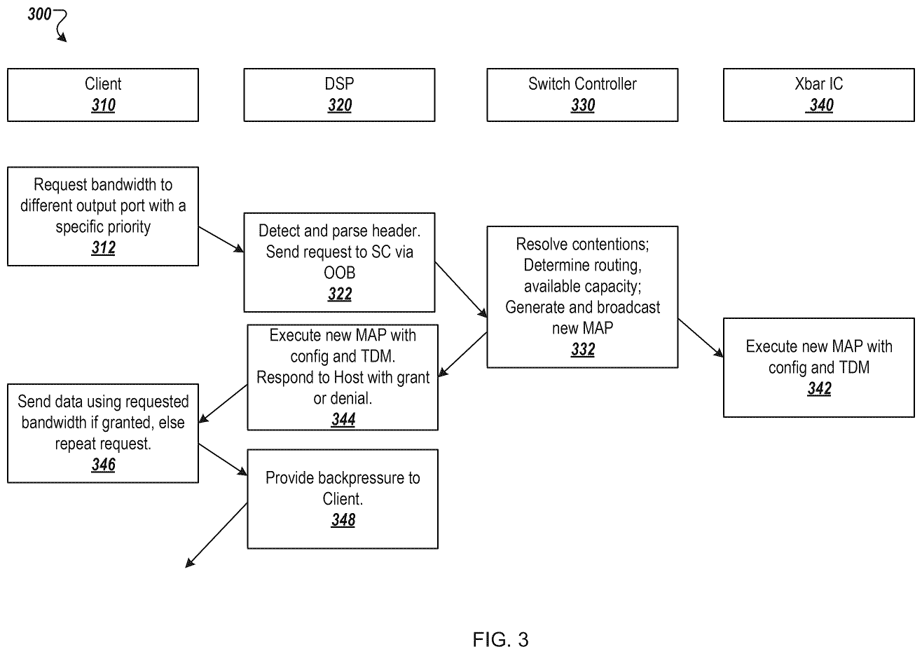

As illustrated in FIG. 3, a timing diagram 300 showing communication between a client 310, a DSP 320, a switch controller 330, and a crossbar IC 340 (i.e., including analog crossbars) is illustrated. The client 310 may communicate with DSP 320 by requesting bandwidth to a different output port with a specific priority, as in block 312. DSP 320 may detect and parse the header and send a request to the switch controller 330 via out-of-band communication, as in block 322. Switch controller 330 may resolve contentions, determine routing and available capacity, and generate and broadcast new MAP, as in block 332. Crossbar IC 340 may execute the new MAP with configuration and TDM, as in block 342. DSP 320 may execute new MAP with configuration and TDM, and respond to the host with grant or denial, as in block 344. The client 310 may send data using requested bandwidth if granted, or else repeat the request, as in block 346. DSP 320 may provide backpressure to client 310, as in block 348.

In addition or alternatively, the AECS may be an optical circuit switch (OCS). The OCS may be synchronized to facilitate faster switching using e.g., a common time base or IEEE 1588. Thus, any technique suitable for an AECS may be applied to an OCS.

For example, in some examples, synchronized reconfiguration across multiple layers is implemented by coordination capabilities of the switch controller. Real-world scenarios like failovers and load balancing can be managed seamlessly. The integration of in-band signaling, alongside OOB communication, provides additional flexibility and reliability, ensuring uninterrupted operation even in complex and dynamic environments. Through advanced techniques such as predefined states, dynamic topology updates, and cross-layer feedback, synchronized reconfiguration continues to evolve, addressing the challenges of modern networking and data-intensive applications, which is described in detail below.

Synchronized reconfiguration across multiple layers of a network architecture, such as DSPs, crossbars, and switch controllers, is advantageous for maintaining operational continuity during dynamic events like failovers, load balancing, and path optimization. This process ensures that changes in the configuration of one layer do not introduce disruptions or delays in other interconnected layers. The combination of precise coordination, advanced signaling protocols, and real-time monitoring facilitates seamless reconfiguration, avoiding latency spikes or data loss.

At the core of synchronized reconfiguration lies the switch controller, which acts as the orchestrator for all reconfiguration events. The switch controller communicates with DSPs and crossbars using synchronization signals to coordinate the timing of transitions. By maintaining a common time base and leveraging preconfigured schedules, the switch controller ensures that crossbars and DSPs align their activities during reconfiguration.

For example, during a failover event, the switch controller identifies the affected paths and determines the redundant resources required to maintain connectivity. It then sends synchronization signals to the DSPs, instructing them to activate auxiliary transceivers and reroute traffic through redundant crossbars. Simultaneously, the crossbars receive signals to adjust their switching paths to accommodate the new traffic flow. This tightly coordinated process prevents asynchronous transitions that could lead to packet loss or jitter.

Synchronized reconfiguration is particularly advantageous in real-world scenarios where even minor disruptions can have cascading effects, such as network failover, load balancing, path optimization, which is discussed in detail below. For example, in data centers or telecommunications networks, hardware or link failures are inevitable. Synchronized reconfiguration ensures that traffic is seamlessly rerouted to redundant paths without interrupting ongoing data flows. For instance, when a primary path fails, the switch controller activates redundant lanes and coordinates their integration into the traffic flow. This process occurs in real time, preventing latency spikes and packet drops that could otherwise degrade the performance of critical applications.

Dynamic load balancing requires the redistribution of traffic across available resources to avoid congestion. Synchronized reconfiguration enables this redistribution by aligning DSPs and crossbars to transition traffic between paths smoothly. For example, during peak traffic hours in a content delivery network, the switch controller may dynamically redistribute traffic to underutilized crossbars and DSPs, maintaining high throughput and minimizing latency.

In optical networks, where high bandwidth and low latency are paramount, synchronized reconfiguration is essential for maintaining quality of service. The switch controller can dynamically adjust optical paths in response to changes in network conditions, such as increased demand or equipment failure. By coordinating DSPs and crossbars, the system ensures uninterrupted data transmission during reconfiguration.

While out-of-band (OOB) signaling is commonly used for managing reconfiguration events, in-band (IB) signaling can complement this approach in certain scenarios. In-band signaling involves embedding control messages directly within the data flow, eliminating the need for separate communication channels. This technique can be particularly useful in environments where OOB channels are unavailable or underutilized.

For example, during synchronized reconfiguration, in-band signaling can be used to transmit updates about path adjustments, buffer states, or traffic priorities directly to DSPs and crossbars. These updates are seamlessly integrated into the data flow, ensuring that all components receive real-time information without additional latency. In hybrid systems, a combination of IB and OOB signaling can enhance reliability by providing redundant communication paths for reconfiguration commands.

### Advanced Techniques for Synchronized Reconfiguration

To further improve the efficiency and precision of synchronized reconfiguration, advanced techniques can be employed. For example, via predefined reconfiguration states. In some examples, the switch controller may maintain a library of predefined states for DSPs and crossbars, allowing rapid transitions during reconfiguration. For instance, in a failover scenario, the system may quickly switch to a preconfigured state that mirrors the redundant path, minimizing the time required for adjustment.

In some examples, by continuously monitoring network conditions, the switch controller can update its reconfiguration strategies in real time. For example, if a spike in traffic is detected in a specific region of the network, the controller can proactively redistribute traffic and synchronize DSPs and crossbars to handle the increased load. In some examples, integrating cross-layer feedback loops between DSPs, crossbars, and the switch controller ensures that reconfiguration decisions are based on accurate and up-to-date information. For example, if a crossbar reports congestion or degradation, the controller can adjust its reconfiguration strategy to prioritize affected paths.

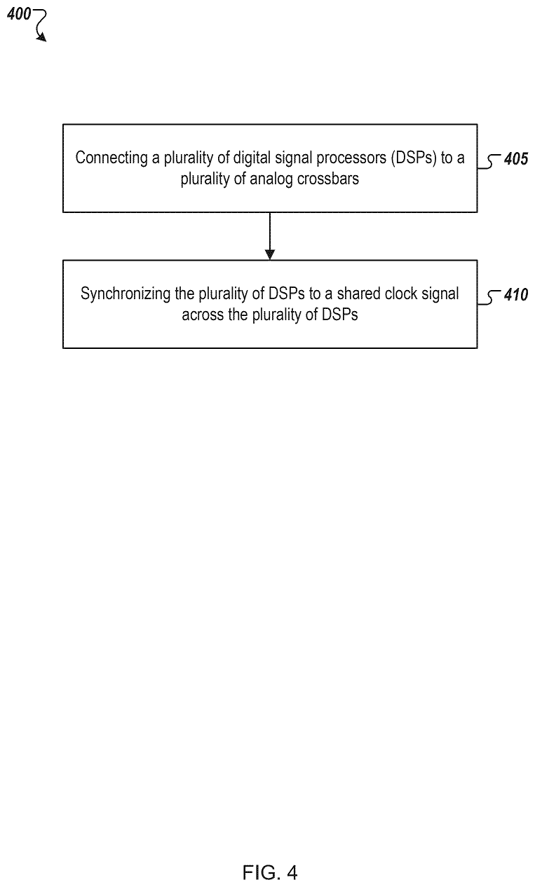

FIG. 4 illustrates a process flow of an example method 400 of synchronization, in accordance with at least one example described in the present disclosure. The method 400 may be arranged in accordance with at least one example described in the present disclosure.

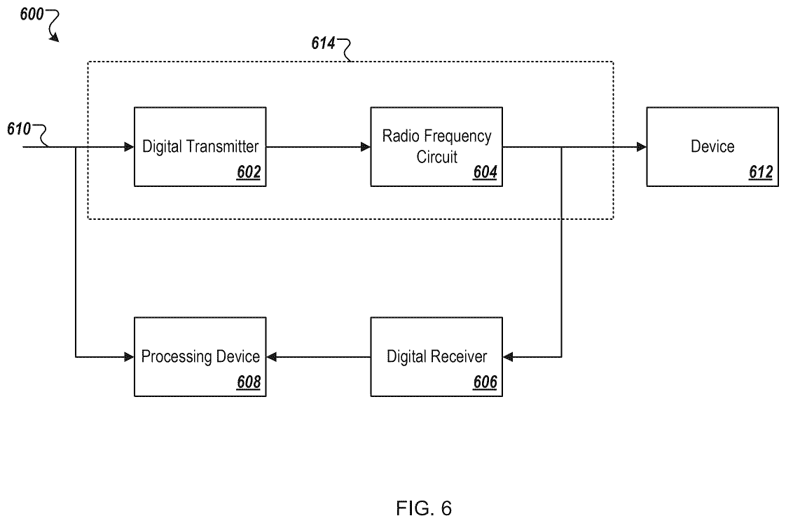

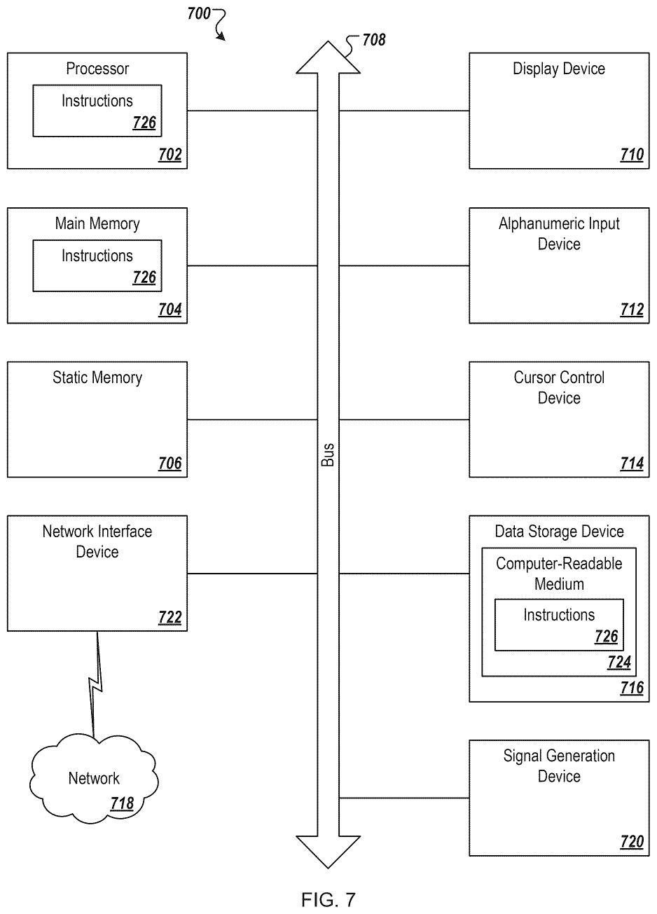

The method 400 may be performed by processing logic that may include hardware (circuitry, dedicated logic, etc.), software (such as is run on a computer system or a dedicated machine), or a combination of both, which processing logic may be included in the processing device 702 of FIG. 7, the communication system 600 of FIG. 6, or another device, combination of devices, or systems. In some examples, the method 400 may begin at block 405 where the processing logic may connect digital signal processors (DSPs) to analog crossbars. At block 410, the processing logic may synchronize DSPs to a shared clock signal across the DSPs.

The processing logic may maintain synchronization between the DSPs using IEEE 1588. The processing logic may synchronize reconfiguration between the DSPs and the analog crossbars to facilitate minimum latency between traffic flows. The processing logic may store one or more of previous configuration states or equalization settings to minimize reacquisition time after reconfiguration between the DSPs and the analog crossbars. The processing logic may use backpressure to manage traffic flow during reconfiguration between the DSPs and the analog crossbars to prevent data loss. The processing logic may maintain an independent data rate at the DSPs. The processing logic may use synchronous MAP cycles. The processing logic may reduce one or more of jitter or symbol drift during a traffic transition.

Modifications, additions, or omissions may be made to the method 400 without departing from the scope of the present disclosure. For example, in some examples, the method 400 may include any number of other components that may not be explicitly illustrated or described.

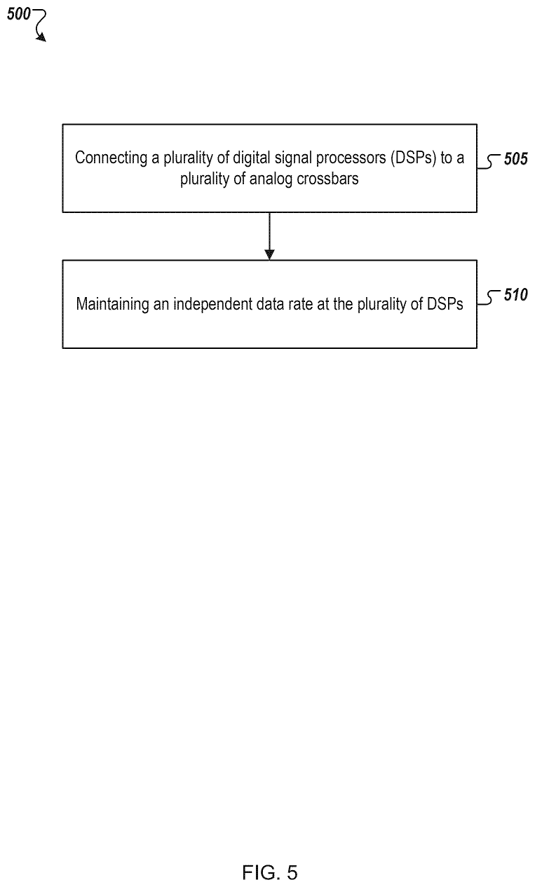

FIG. 5 illustrates a process flow of an example method 500 of synchronization, in accordance with at least one example described in the present disclosure. The method 500 may be arranged in accordance with at least one example described in the present disclosure.

The method 500 may be performed by processing logic that may include hardware (circuitry, dedicated logic, etc.), software (such as is run on a computer system or a dedicated machine), or a combination of both, which processing logic may be included in the processing device 702 of FIG. 7, the communication system 600 of FIG. 6, or another device, combination of devices, or systems.

The method 500 may begin at block 505 where the processing logic may connect digital signal processors (DSPs) to analog crossbars.

At block 510, the processing logic may maintain an independent data rate at the DSPs.

The processing logic may use backpressure to manage traffic flow during reconfiguration between the DSPs and the analog crossbars to prevent data loss.

Modifications, additions, or omissions may be made to the method 500 without departing from the scope of the present disclosure. For example, in some examples, the method 500 may include any number of other components that may not be explicitly illustrated or described.

For simplicity of explanation, methods and/or process flows described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

FIG. 6 illustrates a block diagram of an example communication system 600 configured for synchronization, in accordance with at least one example described in the present disclosure. The communication system 600 may include a digital transmitter 602, a radio frequency circuit 604, a device 612, a digital receiver 606, and a processing device 608. The digital transmitter 602 and the processing device may be configured to receive a baseband signal via connection 610. A transceiver 614 may comprise the digital transmitter 602 and the radio frequency circuit 604.

In some examples, the communication system 600 may include a system of devices that may be configured to communicate with one another via a wired or wireline connection. For example, a wired connection in the communication system 600 may include one or more Ethernet cables, one or more fiber-optic cables, and/or other similar wired communication mediums. Alternatively, or additionally, the communication system 600 may include a system of devices that may be configured to communicate via one or more wireless connections. For example, the communication system 600 may include one or more devices configured to transmit and/or receive radio waves, microwaves, ultrasonic waves, optical waves, electromagnetic induction, and/or similar wireless communications. Alternatively, or additionally, the communication system 600 may include combinations of wireless and/or wired connections. In these and other examples, the communication system 600 may include one or more devices that may be configured to obtain a baseband signal, perform one or more operations to the baseband signal to generate a modified baseband signal, and transmit the modified baseband signal, such as to one or more loads.

In some examples, the communication system 600 may include one or more communication channels that may communicatively couple systems and/or devices included in the communication system 600. For example, the transceiver 614 may be communicatively coupled to the device 612.

In some examples, the transceiver 614 may be configured to obtain a baseband signal. For example, as described herein, the transceiver 614 may be configured to generate a baseband signal and/or receive a baseband signal from another device. In some examples, the transceiver 614 may be configured to transmit the baseband signal. For example, upon obtaining the baseband signal, the transceiver 614 may be configured to transmit the baseband signal to a separate device, such as the device 612. Alternatively, or additionally, the transceiver 614 may be configured to modify, condition, and/or transform the baseband signal in advance of transmitting the baseband signal. For example, the transceiver 614 may include a quadrature up-converter and/or a digital to analog converter (DAC) that may be configured to modify the baseband signal. Alternatively, or additionally, the transceiver 614 may include a direct radio frequency (RF) sampling converter that may be configured to modify the baseband signal.

In some examples, the digital transmitter 602 may be configured to obtain a baseband signal via connection 610. In some examples, the digital transmitter 602 may be configured to up-convert the baseband signal. For example, the digital transmitter 602 may include a quadrature up-converter to apply to the baseband signal. In some examples, the digital transmitter 602 may include an integrated digital to analog converter (DAC). The DAC may convert the baseband signal to an analog signal, or a continuous time signal. In some examples, the DAC architecture may include a direct RF sampling DAC. In some examples, the DAC may be a separate element from the digital transmitter 602.

In some examples, the transceiver 614 may include one or more subcomponents that may be used in preparing the baseband signal and/or transmitting the baseband signal. For example, the transceiver 614 may include an RF front end (e.g., in a wireless environment) which may include a power amplifier (PA), a digital transmitter (e.g., 602), a digital front end, an Institute of Electrical and Electronics Engineers (IEEE) 1588v2 device, a Long-Term Evolution (LTE) physical layer (L-PHY), an (S-plane) device, a management plane (M-plane) device, an Ethernet media access control (MAC)/personal communications service (PCS), a resource controller/scheduler, and the like. In some examples, a radio (e.g., a radio frequency circuit 604) of the transceiver 614 may be synchronized with the resource controller via the S-plane device, which may contribute to high-accuracy timing with respect to a reference clock.

In some examples, the transceiver 614 may be configured to obtain the baseband signal for transmission. For example, the transceiver 614 may receive the baseband signal from a separate device, such as a signal generator. For example, the baseband signal may come from a transducer configured to convert a variable into an electrical signal, such as an audio signal output of a microphone picking up a speaker's voice. Alternatively, or additionally, the transceiver 614 may be configured to generate a baseband signal for transmission. In these and other examples, the transceiver 614 may be configured to transmit the baseband signal to another device, such as the device 612.

In some examples, the device 612 may be configured to receive a transmission from the transceiver 614. For example, the transceiver 614 may be configured to transmit a baseband signal to the device 612.

In some examples, the radio frequency circuit 604 may be configured to transmit the digital signal received from the digital transmitter 602. In some examples, the radio frequency circuit 604 may be configured to transmit the digital signal to the device 612 and/or the digital receiver 606. In some examples, the digital receiver 606 may be configured to receive a digital signal from the RF circuit and/or send a digital signal to the processing device 608.

In some examples, the processing device 608 may be a standalone device or system, as illustrated. Alternatively, or additionally, the processing device 608 may be a component of another device and/or system. For example, in some examples, the processing device 608 may be included in the transceiver 614. In instances in which the processing device 608 is a standalone device or system, the processing device 608 may be configured to communicate with additional devices and/or systems remote from the processing device 608, such as the transceiver 614 and/or the device 612. For example, the processing device 608 may be configured to send and/or receive transmissions from the transceiver 614 and/or the device 612. In some examples, the processing device 608 may be combined with other elements of the communication system 600.

FIG. 7 illustrates a diagrammatic representation of a machine in the example form of a computing device 700 within which a set of instructions, for causing the machine to perform any one or more of the methods discussed herein, may be executed. The computing device 700 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative examples, the machine may be connected (e.g., networked) to other machines in a local area network (LAN), an intranet, an extranet, or the Internet. The machine may operate in the capacity of a server machine in client-server network environment. Further, while only a single machine is illustrated, the term “machine” may also include any collection of machines that individually or jointly execute a set (or multiple sets) of instructions to perform any one or more of the methods discussed herein.

The example computing device 700 includes a processing device (e.g., a processor) 702, a main memory 704 (e.g., read-only memory (ROM), flash memory, dynamic random access memory (DRAM) such as synchronous DRAM (SDRAM)), a static memory 706 (e.g., flash memory, static random access memory (SRAM)) and a data storage device 716, which communicate with each other via a bus 708.

Processing device 702 represents one or more general-purpose processing devices such as a microprocessor, central processing unit, or the like. More particularly, the processing device 702 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 702 may also include one or more special-purpose processing devices such as an application specific integrated circuit (ASIC), a field programmable gate array (FPGA), a digital signal processor (DSP), network processor, or the like. The processing device 702 is configured to execute instructions 726 for performing the operations and steps discussed herein.

The computing device 700 may further include a network interface device 722 which may communicate with a network 718. The computing device 700 also may include a display device 710 (e.g., a liquid crystal display (LCD) or a cathode ray tube (CRT)), an alphanumeric input device 712 (e.g., a keyboard), a cursor control device 714 (e.g., a mouse) and a signal generation device 720 (e.g., a speaker). In at least one example, the display device 710, the alphanumeric input device 712, and the cursor control device 714 may be combined into a single component or device (e.g., an LCD touch screen).

The data storage device 716 may include a computer-readable storage medium 724 on which is stored one or more sets of instructions 726 embodying any one or more of the methods or functions described herein. The instructions 726 may also reside, completely or at least partially, within the main memory 704 and/or within the processing device 702 during execution thereof by the computing device 700, the main memory 704 and the processing device 702 also constituting computer-readable media. The instructions may further be transmitted or received over a network 718 via the network interface device 722.

While the computer-readable storage medium 724 is shown in an example to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

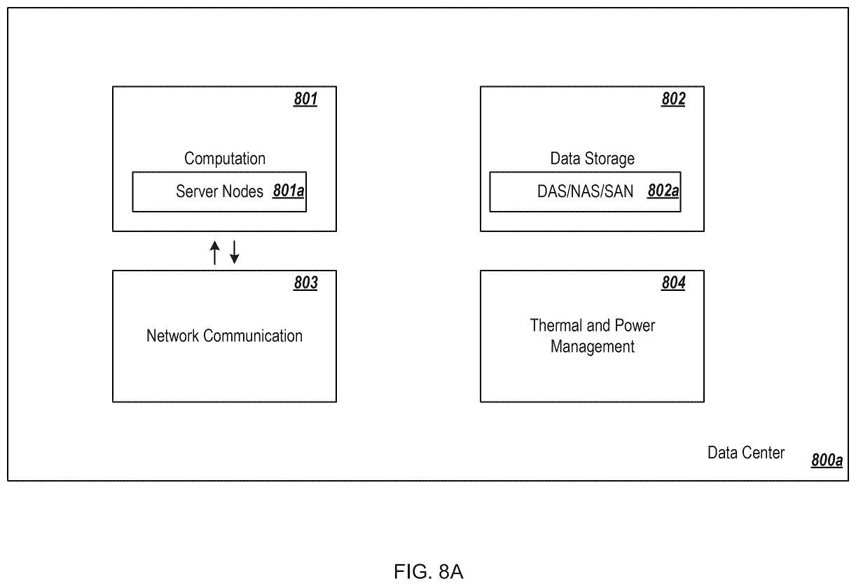

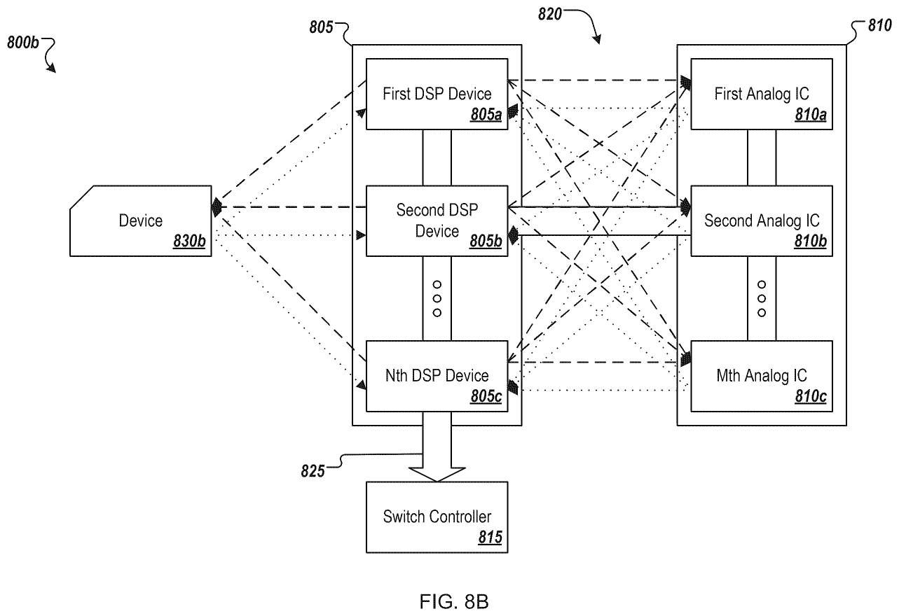

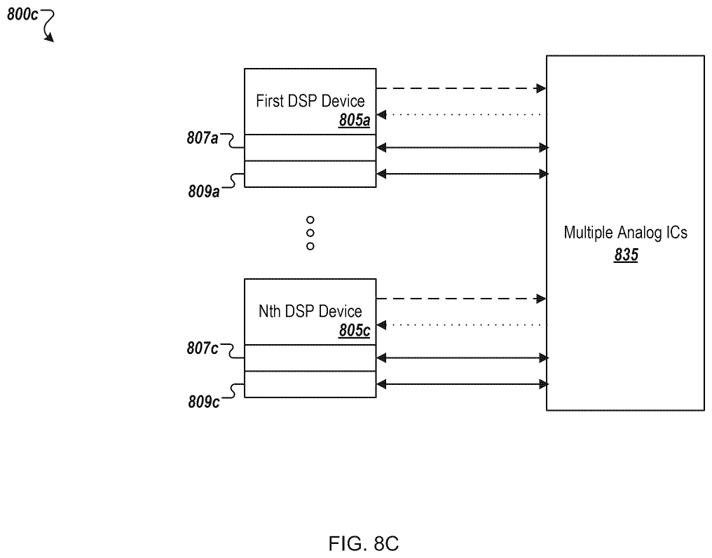

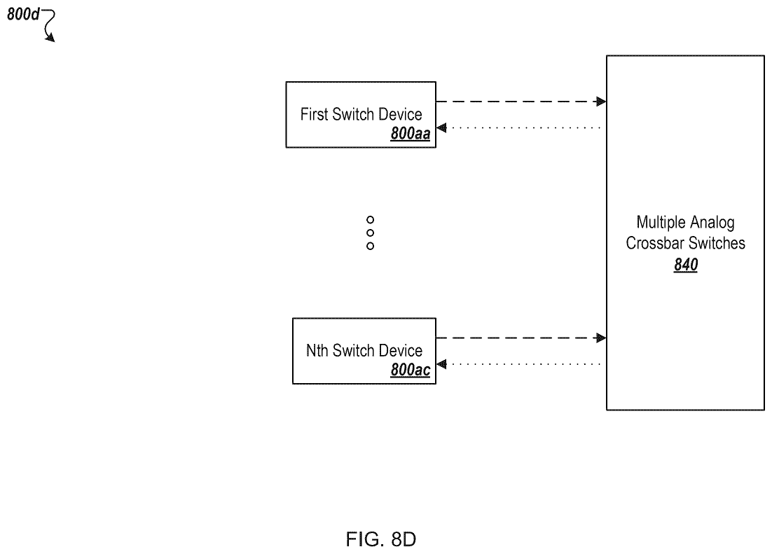

As illustrated in FIG. 8A, a block diagram of a data center 800a may include multiple subsystems configured to perform various operational functions, including computation 801, data storage 802, network communication 803, and thermal and power management 804. The computation 801 subsystem may include one or more server nodes 801a that may execute software applications and process data workloads. The data storage 802 subsystem may provide persistent data retention through devices such as hard disk drives, solid-state drives, or distributed storage arrays, which may be organized in configurations such as Direct Attached Storage (DAS), Network Attached Storage (NAS), or Storage Area Networks (SAN) 802a. The networking communication 803 subsystem may facilitate bidirectional data transfer between servers and external networks through high-speed switching and routing components. The thermal and power management 804 subsystem may maintain operational integrity by regulating temperature and supplying uninterrupted electrical power, e.g., through redundant power sources and cooling mechanisms. Each subsystem may operate in coordination to ensure continuous availability, scalability, and fault tolerance and the ability to scale up and scale out in response to increasing computational and storage demands.

The architecture of a data center 800a may include multiple physical and logical components that collectively enable high-performance computing and data handling. The compute layer may include server racks populated with processors optimized for general-purpose or specialized workloads, including central processing units (CPUs), graphics processing units (GPUs), and field-programmable gate arrays (FPGAs). The storage layer may incorporate hierarchical storage systems that may employ high-speed interfaces such as Non-Volatile Memory Express (NVMe) to reduce latency. The networking layer may use top-of-rack switches, aggregation switches, and core routers arranged in various topologies, (e.g., crossbar, Clos, leaf-spine, etc.) to provide non-blocking connectivity and minimize hop count between endpoints. Power distribution units (PDUs), uninterruptible power supplies (UPS), and backup generators may form the electrical infrastructure, while cooling systems may employ air-based or liquid-based heat dissipation techniques to maintain thermal stability. These components may be integrated to achieve high reliability, modular scalability, and compliance with performance, enabling the system to scale up and scale out as operational loads increase.

In operation, a data center may process client requests through a multi-stage workflow that includes traffic distribution, application execution, and data retrieval. Incoming requests may be received by a load balancing system configured to allocate workloads across multiple compute nodes to prevent resource saturation. Application servers may execute the requested operations, which may involve accessing structured or unstructured data stored within the storage subsystem. Virtualization technologies may enable multiple virtual machines to operate on a single physical server, thereby optimizing resource utilization. Containerization frameworks, such as those implementing Linux containers, may provide isolated execution environments for microservices and facilitate rapid deployment across heterogeneous hardware. The networking subsystem may ensure deterministic packet routing and congestion management through high-speed interconnects and software-defined networking protocols. This operational workflow may be designed to maintain low latency, high throughput, and fault-tolerant performance under variable load conditions, while supporting the ability to scale up and scale out dynamically.

Conventional data center implementations may exhibit several advancements aimed at improving efficiency, scalability, and sustainability. Hyperscale architectures may employ large-scale server clusters interconnected through high-bandwidth fabrics to support cloud computing and artificial intelligence workloads. Edge computing deployments may position micro data centers proximate to end-user devices to reduce network latency and enable real-time processing. Specialized accelerators, including GPUs and tensor processing units (TPUs), may be increasingly integrated to support machine learning and high-performance computing applications. Energy efficiency initiatives may incorporate renewable energy sources and advanced cooling methodologies, such as liquid immersion cooling, to reduce operational costs and environmental impact. These trends reflect an industry-wide transition toward architectures that may be highly distributed, workload-optimized, and environmentally sustainable.

A scale-up network architecture may be characterized by the addition of resources within a single network node or chassis to increase capacity. In such configurations, performance improvements may be achieved by augmenting the processing capability, memory, or port density of an existing switch or router. This approach may involve deploying high-capacity modular switches with vertically integrated backplanes and high-bandwidth switch fabrics. The scale-up model may be advantageous for environments having centralized control and minimal inter-node latency, as all traffic may be processed within a single logical device.

A scale-out network architecture may be characterized by the horizontal expansion of network capacity through the addition of multiple interconnected nodes. In this configuration, performance and scalability may be achieved by distributing workloads across multiple switches, for example arranged as a leaf-spine architecture. Each leaf switch may provide connectivity to compute and storage resources, while spine switches interconnect the leaf layer to form a non-blocking, high-bandwidth fabric. The scale-out model may enable incremental capacity expansion without replacing existing infrastructure, thereby supporting elastic growth and fault tolerance. This architecture may be particularly suited for large-scale data centers and cloud environments, where traffic patterns may be highly distributed and use predictable bandwidth. Scale-out networks may leverage parallelism and redundancy to achieve near-linear scalability.

A scale-up network may carry information, including AI training and inference algorithms, among computing units (such as graphics processing units (GPUs)). These networks may have various characteristics such as high bandwidth (e.g., non-blocking all-to-all bandwidth), low latency (e.g., minimize layers of switching and per-switch latency), and scalability (e.g., supporting high numbers of interconnected GPUs and low energy per bit transferred through network). For purposes of this disclosure, a “GPU” has been provided as an example and instances of GPU may be substituted by any type of processor such as CPUs, ASICs, or the like.

Conventional scale-up networks may centralize the switching/routing function in order to scale GPU connectivity across multiple rack units and even multiple racks. An example compute rack may include 18 compute trays consuming about 6 kW each, and 9 switch trays consuming about 1 kW each. Each GPU may have 18 ports of 100 GB/s each (or 1.8 TB/s per GPU), and the rack network (which may be implemented using a copper backplane) may connect each GPU to the 9 switch trays to provide each GPU with the ability to deliver all of its 1.8 TB/s to any other GPU in the rack, a capability often referred to as “All-to-All bandwidth”. This may be used for parallelizing the computation of an AI model for training or inference purposes.

This rack-level power density may be quite high and push the limit of electrical power and thermal cooling densities, leaving little room for additional compute trays. Furthermore, switch connectivity for all-to-all crossbar-like functionality has complexity and power which may vary quadratically with the number of ports being interconnected, so scaling the GPUs connected within a rack may be constrained, even when the number of GPUs may be increased.

A centralized full crossbar may be replaced with distributed crossbars which places ultra-efficient, ultra-low-latency analog crossbars locally with their respective GPUs, and routes them to digital switch SOCs with an arrangement of crossbars which may be simplified compared with full crossbars. This may drive improvements in network power, latency, complexity, and scalability.

As a result, network traffic (e.g., which may be AI traffic) may be matched with low predictable latency providing all-to-all bandwidth. Compared to Ethernet packet switches, ⅕ of the power may be consumed. The device may be capable of high radix implementations (e.g., 1024 lanes). The device may be usable in all-copper backplane scale ups as well as with multi-mode (MM) fiber.

Thus, the examples described herein present systems and methods for an Analog Electrical Circuit Switch (AECS) switch capable of ultra-low-latency (e.g., <5 ns, 10 ns, or the like) and low-power switching across a flexible any-to-any crossbar architecture. The AECS switch eliminates internal buffering and packet inspection within the crossbar, allowing for a highly efficient and scalable architecture. A programmable crossbar configuration may dynamically map input ports to output ports in response to real-time traffic conditions.

An example system may include advanced control mechanisms for broadcasting and multicasting data from a single input to multiple outputs, optimizing resource allocation and minimizing overhead. Make-before-break (MBB) protocols may be employed to ensure seamless reconfiguration of crossbar connections without data loss, even during high-speed operations. Additionally, adaptive equalization techniques may be integrated into the system, allowing the AECS to optimize signal quality based on feedback from connected devices.

An architecture may include redundancies along with digital signal processors (DSPs) configured to support any-to-any connections. In such an arrangement, low-latency switching along with low power use per lane may be achieved. Further, memory included in the DSPs may be used for any storage or buffering and each of the components included in the switch may include redundant lanes such that degradations or broken DSPs may be rerouted around and replaced without losses to the system. The reconfiguration in the switch may be dynamically performed (e.g., such as in view of real-time traffic managed by the switch) by a switch controller that may communicate with the components in the switch using out-of-band traffic so as to not interfere with the in-band communications otherwise being handled by the switch.

FIG. 8B illustrates an example switch device 800b. The switch device 800b may include a first digital signal processor (DSP) device 805a, a second DSP device 805b, an nth DSP device 805c, referred to collectively as multiple first electronic devices 805, a first analog integrated circuit (IC) 810a, a second analog IC 810b, an mth analog IC 810c, referred to collectively as multiple second electronic devices 810, a switch controller 815, in-band traffic 820, and out-of-band traffic 825. First DSP 805a, second DSP 805b, and nth DSP 805c may have input and output.

The switch device 800b may be reconfigurable (e.g., in terms of the connections between the components therein, such as the multiple first electronic devices 805 and the multiple second electronic devices 810, the switch controller 815, and/or a device 830), where the switching of the connections/lanes between the components may be low latency (e.g., less than 5 ns, 10 ns, or the like switching). Alternatively, or additionally, the switch device 800b may reconfigure without the use of retiming such that each lane of the multiple lanes included therein may use less than 50 mW of power. For example, each lane of the multiple lanes may support 100G bandwidth while using less than 50 mW of power.

The multiple first electronic devices 805 may individually include one or more ports that may be used to facilitate communications within the switch device 800b, such as between the multiple first electronic devices 805 and the multiple second electronic devices 810, the switch controller 815, and/or a device 830. The communications in the switch device 800b may be transmitted via multiple lanes in the switch device 800b. The multiple lanes may facilitate the in-band traffic 820 and/or the out-of-band traffic 825.

The multiple lanes between the multiple first electronic devices 805 and the multiple second electronic devices 810 may be in an any-to-any configuration. For example, the first DSP device 805a may include a lane to the first analog IC 810a, to the second analog IC 810b, and/or the mth analog IC 810c. A similar arrangement may occur for each of the multiple first electronic devices 805, such that each DSP device of the multiple first electronic devices 805 may include a lane to any number of the multiple second electronic devices 810, including none of the multiple second electronic devices 810. Each lane for facilitating the in-band traffic 820 may be in both directions (e.g., transmit and receive) between the multiple first electronic devices 805, the multiple second electronic devices 810, and/or a device 830. Alternatively, or additionally, the lanes are dashed/dotted to illustrate that for any transmit/receive path between the multiple first electronic devices 805, the multiple second electronic devices 810, and/or a device 830, a lane may or may not be present.

The multiple first electronic devices 805, the multiple second electronic devices 810, and/or the switch controller 815 may be disposed on a printed circuit board (PCB) where traces on the PCB may be used to connect at least the multiple first electronic devices 805, the multiple second electronic devices 810, and/or the switch controller 815 (e.g., the traces on the PCB may facilitate the in-band traffic 820 and/or the out-of-band traffic 825 in the switch device 800b). Alternatively, or additionally, the multiple first electronic devices 805, the multiple second electronic devices 810, and/or the switch controller 815 may be connected to one another using connectors, such as high-speed cables, where the multiple first electronic devices 805, the multiple second electronic devices 810, and/or the switch controller 815 may individually include ports/headers to support the use of the connectors. In instances in which the connectors are used, crosstalk between the multiple lanes in the switch device 800b may be reduced relative to the crosstalk that may occur when the switch device 800b uses traces on a PCB.

The switch device 800b, including the multiple first electronic devices 805, the multiple second electronic devices 810, and/or the switch controller 815, may be utilized with one or more additional switches and/or crossbar devices to form a new crossbar switch device, which may be larger than any one of the switch devices 800b. For example, as illustrated and discussed relative to FIG. 8C, the switch device 800b may be utilized with any other number of switch devices 800b (e.g., the nth switch device 800ac in FIG. 8C) and multiple analog crossbar switches 840 to form a new crossbar switch device.

The multiple first electronic devices 805 may be digital signal processors (DSPs) and/or the multiple second electronic devices 810 may be analog circuit switch integrated circuits (ICs) for use with electrical signals. Alternatively, or additionally the multiple second electronic devices 810 may be analog optical circuit switch ICs for use with optical signals. The multiple first electronic devices 805 may be individually configured to support one or more layer of the open systems interconnection (OSI) model. For example, each of the multiple first electronic devices 805 may be configured to support layer 1 protocols, layer 2 protocols, and/or layer 3 protocols with respect to the in-band traffic 820 and/or the out-of-band traffic 825.

Each, or at least one, of the multiple first electronic devices 805 may support layer 1 protocols, which may include detecting and/or processing layer 2 protocols and/or layer 3 protocols, handling layer 2 protocol and/or layer 3 protocol addressability, frame header detection, packet header inspection, responding to layer 2 protocol and/or layer 3 protocol requests, storing information in response to a request associated with layer 2 protocols and/or layer 3 protocols, updating information in response to a request associated with layer 2 protocols and/or layer 3 protocols, communicating information in response to a request associated with layer 2 protocols and/or layer 3 protocols, optimizing information in response to a request associated with layer 2 protocols and/or layer 3 protocols, etc. Each of the multiple first electronic devices 805 may be able to adjust the way in which traffic is directed through it, such as in response to a command from the switch controller 815. For example, each of the multiple first electronic devices 805 may be operable to configure an internal switch, an external switch, or a crossbar based on the various layer protocol processing to be performed.

The first DSP device 805a may receive a communication that includes a frame header (or a packet header) and the first DSP device 805a may be configured to detect the frame header and decode the frame header along with any associated contents of the communication, all within the first DSP device 805a. In a second example, the first DSP device 805a may integrate a media access control (MAC) address lookup table which may allow the first DSP device 805a to configure one or more crossbars such that the first DSP device 805a may facilitate connectivity between any two MAC addresses that are included in the lookup table. Alternatively, or additionally, each of the first electronic devices 805 may include a lookup table that may store equalization settings that may be used for various connections between the first electronic devices 805 and other components within the switch device 800b. The equalization settings in the lookup table may be used to accelerate acquisition and/or tracking for a particular DSP device of the multiple first electronic devices 805 when the particular DSP device switches connections within the switch device 800b.

The multiple first electronic devices 805 may be configured to respond to layer 2 protocol requests and/or layer 3 protocol requests for connectivity and/or resource grant requests. For example, the multiple first electronic devices 805 may compare a request to a lookup table that includes priority levels and the multiple first electronic devices 805 may be operable to configure themselves and/or associated crossbars and/or switches based on the determined priority level. Alternatively, or additionally, each of the multiple first electronic devices 805 may be configured to respond to in-band requests (e.g., granting a connection request, signaling backpressure to the device 830, etc.), collect statistics on traffic handled by the multiple first electronic devices 805 (e.g., link utilization and/or traffic type), and/or perform data filtering (e.g., detecting a particular header, performing routing, generating flags and/or interrupts, and/or logging any of the filtering events).

The multiple first electronic devices 805 may be configured to communicate with (e.g., transmit data to and/or receive data from) the device 830. The communication with the device 830 may include in-band traffic 820. In such instances, the communications between the multiple first electronic devices 805 and the device 830 may be line-side communications, where the lines may facilitate communications using various communication channels. For example, the line-side communications between the multiple first electronic devices 805 and the device 830 may be an electrical-to-electrical connection, an optical-to-optical connection, an electrical-to-optical connection, or an optical-to-electrical connection, and so forth.

The device 830 may address communications directly to one of the multiple first electronic devices 805. For example, the device 830 may address communications to the second DSP device 805b. Alternatively, or additionally, the device 830 may address communications to the switch controller 815, which may then direct communications to the appropriate DSP device. For example, the device 830 may address communications intended for the second DSP device 805b to the switch controller 815 and the switch controller 815 may direct the communications to the second DSP device 805b.

The multiple first electronic devices 805 may individually include memory that may be used as a buffer for communications through the multiple first electronic devices 805. The memory in the multiple first electronic devices 805 may be utilized to buffer incoming and/or outgoing traffic, which may include in-band traffic 820 and/or out-of-band traffic 825. Due to the memory in the multiple first electronic devices 805 being distributed (e.g., by the distributed nature of the multiple first electronic devices 805), the switch device 800b may not include any memory for buffering in addition to the memory included in the multiple first electronic devices 805.

The multiple first electronic devices 805 may individually include one or more additional lanes that may be used for communications in the switch device 800b. Further details associated with the additional lanes are included in the description associated with FIG. 8C.

The multiple second electronic devices 810 may individually include one or more ports that may be used to facilitate communications within the switch device 800b, similar to the ports described relative to the multiple first electronic devices 805. Alternatively, or additionally, the lanes for communications between the multiple first electronic devices 805 and the multiple second electronic devices 810 may be coupled with the ports included in the multiple second electronic devices 810.

The switch controller 815 may be a microcontroller unit (MCU). Alternatively, or additionally, the switch controller 815 may be a DSP, or other processing device. The switch controller 815 may be communicatively coupled with at least the multiple first electronic devices 805 and/or the multiple second electronic devices 810. The switch controller 815 may resolve resource grant requests, distribute the network state to the multiple first electronic devices 805 and/or to the multiple second electronic device 810, and/or may establish and/or maintain timing among the components included in the switch device 800b.

The switch controller 815 may communicate with the multiple first electronic devices 805 and/or the multiple second electronic devices 810 using a separate connection/lane than the connections between the multiple first electronic devices 805 and the multiple second electronic devices 810. For example, the first connection between the multiple first electronic devices 805 and the multiple second electronic devices 810 may facilitate the in-band traffic 820 and the second connection between the switch controller 815 and the multiple first electronic devices 805 and/or the multiple second electronic devices 810 may facilitate the out-of-band traffic 825.

The out-of-band traffic 825 may use a different network than the in-band traffic 820. Alternatively, or additionally, the out-of-band traffic 825 may use a different physical layer protocol than the in-band traffic 820. The out-of-band traffic 825 may be used to manage and/or configure one or more components included in the switch device 800b. For example, the switch controller 815 may communicate with the multiple first electronic devices 805 using the out-of-band traffic 825 to reconfigure lanes and/or traffic routing based on the traffic through the switch device 800b.

The switch controller 815 may be programmable such that the switch controller 815 may be operable to dynamically map the lanes between the multiple first electronic devices 805 and the multiple second electronic devices 810. For example, in instances in which the first DSP device 805a includes a lane to the first analog IC 810a, the switch controller 815 may dynamically map the lane to be from the first DSP device 805a to the second analog IC 810b. The switch controller 815 may dynamically adapt the mapping of the lanes between the multiple first electronic devices 805 and the multiple second electronic devices 810 based on one or more conditions and/or a satisfaction of a threshold related to the conditions. For example, in instances in which the real-time data traffic in the switch device 800b (or an amount of real-time data traffic handled by one of the multiple first electronic devices 805 and/or one of the multiple second electronic devices 810) satisfies a threshold, the switch controller 815 may dynamically adapt the mapping of the lanes as described.

The switch device 800b may include one or more redundant lanes that may be used in various situations during operation of the switch device 800b. For example, one or more redundant lanes may be used for the out-of-band traffic 825, such as signaling using the out-of-band traffic 825. In such instances, the out-of-band signaling may be transmitted and/or received by a particular DSP device and/or by the switch controller 815, and the out-of-band signaling may be a lower transmission rate than the in-band traffic 820. In another example, one or more redundant lanes may be used for out-of-bandwidth broadcasts from the switch controller 815 and/or from one or more of the multiple first electronic devices 805 to other devices in the switch device 800b (e.g., such as other DSP devices).

The switch controller 815 may reserve a portion of bandwidth associated with the in-band traffic 820 in the switch device 800b. The bandwidth reserved by the switch controller 815 may be reserved on a per lane basis of the multiple lanes included in the switch device 800b. For example, a first lane between the first DSP device 805a and the first analog IC 810a may have a first reserved bandwidth and a second lane between the second DSP device 805b and the second analog IC 810b may have a second reserved bandwidth, where the amount of bandwidth reserved may be the same or may differ between the first reserved bandwidth and the second reserved bandwidth. The switch controller 815 may allocate resources within the switch device 800b based on predicted or anticipated traffic (e.g., based on a probabilistic model).

Alternatively, or additionally, the switch controller 815 may monitor the lanes of the multiple lanes in the switch device 800b. The switch controller 815 may monitor the multiple lanes periodically and/or in a round robin manner, such that the lanes of the multiple lanes may observed to determine if failures or degradations may be present in a lane. In instances in which a lane experiences a degradation that satisfies a threshold for an acceptable loss, the switch controller 815 may dynamically remap a new lane in the switch device 800b to replace the degraded lane.

The switch controller 815 may perform adaptive signal equalization to the in-band traffic 820 in the switch device 800b. For example, the multiple first electronic devices 805 may provide feedback to the switch controller 815 relative to the workload handled by the multiple first electronic devices 805, and the switch controller 815 may adaptively manage workloads of the multiple first electronic devices 805 to optimize performance of the switch device 800b.

A backup switch controller (not illustrated) may be included in the switch device 800b. The backup switch controller may be a redundant controller relative to the switch controller 815. The backup switch controller may include the same or similar connections as the switch controller 815 relative to the multiple first electronic devices 805 and/or the multiple second electronic devices 810. The backup switch controller may perform the same or similar operations as the switch controller 815.

FIG. 8C illustrates an example switch device 800c. The switch device 800c may include a first DSP device 805a, an nth DSP device 805c, and multiple analog ICs 835. The first DSP device 805a may include a first auxiliary channel 807a, and a first out-of-band channel 809a. The nth DSP device 805c may include an nth auxiliary channel 807c, and an nth out-of-band channel 809c.

The first DSP device 805a, the nth DSP device 805c, and the multiple analog ICs 835 may be the same or similar as the first DSP device 805a, the nth DSP device 805c, and the multiple second electronic devices 810, respectively, of FIG. 8A and may be operable to perform the same or similar functions as described.

The auxiliary channels 807 (e.g., the first auxiliary channel 807a and the second auxiliary channel 807c) may be individually utilized by each of the DSP devices 805a, 805c as an additional lane for in-band traffic between at least the DSP devices 805a, 805c and the multiple analog ICs 835. The auxiliary channels 807 may be used to redundantly transmit in-band traffic relative to another lane included in the DSP devices 805a, 805c prior to a change in configuration to the corresponding DSP devices 805a, 805c. For example, in instances in which the first DSP device 805a includes a lane to a particular analog IC of the multiple analog ICs 835 and the first DSP device 805a is to be reconfigured (e.g., by a switch controller as described herein), the first auxiliary channel 807a may have a lane mapped to the particular analog IC such that the in-band traffic is redundant between the first DSP device 805a and the particular analog IC prior to reconfiguring the lanes associated with the first DSP device 805a (which reconfiguration may otherwise break the connection between the first DSP device 805a and the particular analog IC).

The auxiliary channels 807 may be used for communication between other near DSP devices. For example, in instances in which the first DSP device 805a is disposed spatially near to the nth DSP device 805c, the first DSP device 805a and the nth DSP device 805c may communicate with one another via the auxiliary channels 807. Such communications may be possible as the channels between near-neighbors may be relatively clean, such that physical layer processing may be simplified and may result in power reduction, latency reduction, a lesser amount of equalization, and/or other benefits to the switch device 800c.

The out-of-band channels 809 may be used to communicate the out-of-band traffic (e.g., the out-of-band traffic 825 of FIG. 8B) on a lane separate from the multiple lanes used to communicate in-band traffic. In such instances, the out-of-band channels 809 may not cause blocking or interference to the in-band traffic between at least the DSP devices 805a, 805c and the multiple analog ICs 835.

FIG. 8D illustrates an example aggregated switch device 800d. The aggregated switch device 800d may include a first switch device 800aa, an nth switch device 800ac, and multiple analog crossbar switches 840. The first switch device 800aa and the nth switch device 800ac may individually be the same or similar as the switch device 800b of FIG. 8B.

The aggregated switch device 800d illustrates that any number of the switch devices 800b (e.g., the first switch device 800aa and the nth switch device 800ac) may be aggregated into another switch device and/or connected to other analog crossbar switches. Each of the switch devices 800b may include multiple DSP devices and multiple analog IC and may be further aggregated into the aggregated switch device 800d using the multiple analog crossbar switches 840. As such, the aggregated switch device 800d may be scaled up or down for any size communication need, by adjusting the switch devices 800b and/or the multiple analog crossbar switches 840 to meet the communication demand.

In some examples, the different components, modules, engines, and services described herein may be implemented as objects or processes that execute on a computing system (e.g., as separate threads). While some of the systems and methods described herein are generally described as being implemented in software (stored on and/or executed by hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although examples of the present disclosure have been described in detail, it should be understood that the various changes, substitutions, and alterations could be made hereto without departing from the spirit and scope of the present disclosure.

What is claimed is:

1. A device, comprising:
a plurality of digital signal processors (DSPs); and
a plurality of analog crossbars operable to be connected to the plurality of DSPs,
wherein timing between the plurality of DSPs is synchronized.

2. The device of claim 1, wherein the plurality of DSPs are synchronized to a shared clock signal.

3. The device of claim 1, wherein the plurality of DSPs are operable to synchronize the timing between the plurality of DSPs using Institute of Electrical and Electronics Engineering (IEEE) 1588.

4. The device of claim 1, wherein the plurality of DSPs are operable to maintain an independent data rate.

5. The device of claim 1, wherein reconfiguration between the plurality of DSPs and the plurality of analog crossbars is synchronized to facilitate reduced latency between traffic flows.

6. The device of claim 1, wherein reacquisition time after reconfiguration between the plurality of DSPs and the plurality of analog crossbars is minimized by using one or more look up tables (LUTs) to store one or more of prior configuration states or equalization settings.

7. The device of claim 1, wherein traffic flow during reconfiguration between the plurality of DSPs and the plurality of analog crossbars is managed using backpressure to prevent data loss.

8. The device of claim 1, wherein the plurality of DSPs are operable to use synchronous medium access protocol (MAP) cycles.

9. The device of claim 1, further comprising a switch controller operable to synchronize the timing between the plurality of DSPs.

10. The device of claim 1, wherein the timing between the plurality of DSPs is synchronized by the plurality of DSPs.

11. The device of claim 1, wherein the timing between the plurality of DSPs is facilitated using a bittide mechanism.

12. A method, comprising:
connecting a plurality of digital signal processors (DSPs) to a plurality of analog crossbars; and
synchronizing the plurality of DSPs to a shared clock signal across the plurality of DSPs.

13. The method of claim 12, further comprising maintaining synchronization between the plurality of DSPs using Institute of Electrical and Electronics Engineering (IEEE) 1588.

14. The method of claim 12, further comprising reducing one or more of jitter or symbol drift during a traffic transition.

15. The method of claim 12, further comprising synchronizing reconfiguration between the plurality of DSPs and the plurality of analog crossbars to facilitate minimum latency between traffic flows.

16. The method of claim 12, further comprising storing one or more of previous configuration states or equalization settings to minimize reacquisition time after reconfiguration between the plurality of DSPs and the plurality of analog crossbars.

17. The method of claim 12, further comprising using backpressure to manage traffic flow during reconfiguration between the plurality of DSPs and the plurality of analog crossbars to prevent data loss.

18. The method of claim 12, further comprising maintaining an independent data rate at the plurality of DSPs.

19. The method of claim 12, further comprising using synchronous medium access protocol (MAP) cycles.

20. A method, comprising:
connecting a plurality of digital signal processors (DSPs) to a plurality of analog crossbars; and
maintaining an independent data rate at the plurality of DSPs.

21. The method of claim 20, further comprising using backpressure to manage traffic flow during reconfiguration between the plurality of DSPs and the plurality of analog crossbars to prevent data loss.
